(19) United States
(12) Patent Application Publication
(10) Pub. No.: US 2008/0135696 A1
(43) Pub. Date: Jun. 12, 2008

(54) Retractable tool stand

(76) Inventors: Thomas R. LeMay, Springfield, MA (US); Nathan Thomas LeMay, Springfield, MA (US)

Correspondence Address: MCCORMICK, PAULDING & HUBER LLP, CITY PLACE II, 185 ASYLUM STREET, HARTFORD, CT, 06103, US

(21) Appl. No.: 11/634,532

(22) Filed: Dec. 6, 2006

(51) Int. Cl. F16M 11/38

(52) U.S. Cl. 248/170

(57) ABSTRACT

A retractable tool stand is provided for use with a tool having a tool head and a generally elongated tool handle extending therefrom. The tool stand is mounted on the tool handle for articulation between a retracted position, where the stand is positioned generally adjacent to the tool handle so as not to interfere with use of the tool, and an extended position, where the stand generally projects away from the tool handle to engage a support surface to prop up and temporarily store the tool in a generally upright or vertical orientation. The tool stand may be directly connected to the tool handle or connected to an adapter unit that can be mounted onto or incorporated as part of the tool handle.

### FIELD OF THE INVENTION

The present invention generally relates to a tool stand, and more particularly relates to a retractable tool stand for propping up and temporarily supporting a tool with an elongated handle in a generally upright or vertical orientation.

### BACKGROUND OF THE INVENTION

Tools having a generally elongated handle are known. Such tools typically comprise a tool head and an elongated, cylindrical handle extending therefrom to be grasped by the user for use of the tool. For example, a conventional push broom design comprises a broom head to which bristles are attached and from which an elongated, cylindrical handle extends. Other tools using this general design include rakes, shovels, mops, floor squeegees, concrete floats, paint rollers with extension handles, and the like. The user of the tool typically grasps the handle and positions the tool head for use, often against a surface or material to be worked on. With a push broom, the user grasps the elongated handle and positions the bristles of the broom against a floor or surface to be swept and cleaned. When the tool is not in use, it is preferable to store it in an upright or vertical orientation, often against a wall. Most tools, however, cannot stay in an upright or vertical orientation by themselves. Thus, when a work task is completed, tools can be stored on hooks, in a storage rack, or simply be leaned against a wall of a garage, closet, shed or room.

Commonly, when one is using a tool, the user may take a break from working, for example, to move an object that is in the way, to use another tool to complete a task, to discard gathered debris, or simply to take a rest. During such a break, the user usually will temporarily leave the tool at a non-storage location, often at the spot where the work is being done, such as in the middle of a yard. At such location, there may not be a wall against which to lean the tool, so the user will often lay the tool on the ground or floor at a spot that may be out of the way but is close to where the task will resume once the break is over. In laying the tool on the ground or floor, the tool is typically positioned in a horizontal orientation where it is less visible than a tool in an upright orientation, especially, for example, in long grass or leaves. Consequently, the user may lose track of where the tool has been placed, or where the work has left off, and waste time either looking for the tool or duplicating work.

A tool laying on the ground or floor also poses many hazards. One who is not aware of the location of the tool and can't see it laying in a horizontal orientation on the ground may trip over the tool. Even the actual user of the tool may be prone to tripping over the tool in its temporary storage location. Similarly, one may step on the tool head and cause the end of the handle to propel upwards and hit the person. An inconspicuously positioned tool may be prone to damage if accidentally stepped on or run over by a car or lawnmower. Further, when a tool is left in a horizontal orientation on the ground, it also poses the risk injury to a user who must reach down to pick up the tool to resume work. Repeated bending down to pick up a tool, especially for task that requires several breaks, can increase the risk of back or muscle injury.

Various designs of tool stands exist for propping up a tool having an elongated handle in a generally upright or vertical orientation. For example, U.S. Pat. No. 5,868,374 describes a push broom stand that slides over the handle of a conventional push broom so that the broom is supported and held in an upright position. However, when the stand is mounted on the broom handle, it remains extended during use and sticks out from the handle. Consequently, the stand poses a hazard when the broom is being used. The stand can limit the areas where the broom can be used by interfering with furniture, a car or bushes. Additionally, the stand can cause damage to furniture, walls or other objects that it may hit or scratch when it is attached to and projecting out from the broom handle. Further, the stand can interfere with the user's grip on the handle. In order to avoid these problems, the user may remove the stand from the broom handle when the broom is being used. However, such solution would require the stand to be mounted on the handle every time the user takes a break, and then removed when the user resumes work. Additionally, the stand itself would need to be temporarily stored when not mounted on the broom handle, which raises separate issues of keeping track of where the stand is located and spending time to retrieve the stand from a temporary position where the user decides to take a break from using the broom.

Existing versions of tool stands that are mounted to tool handles by sliding the stand onto the handle to a desired position are difficult to use with a tool having a varying handle cross-section or a tool with a broad handle portion at the end of the handle away from the tool head, such as a shovel with a closed-loop grip portion at the end. Such handles make it difficult to slide the tool stand into place.

In view of the foregoing, there is a need for a device that permits temporary storage of a tool having an elongated handle in a generally upright orientation without complicated and time consuming set-up and retraction and which further permits the tool to be used without interference from the device. Accordingly, it is a general object of the present invention to provide a retractable tool stand that overcomes the problems and drawbacks associated with the use and temporary storage of a tool having an elongated handle in a generally upright orientation.

There is also a need for a device that can be readily and quickly attached to a tool having an elongated handle, or merely attached to an elongated handle for use with various tools as an after-market attachment. Accordingly, it is a further object of the present invention to provide a retractable tool stand as an after-market attachment that can easily attach to an elongated handle to permit temporary storage of a tool to which the handle is attached in a generally upright orientation.

### SUMMARY OF THE INVENTION

In one aspect of the present invention, a retractable tool stand for supporting a tool having a tool head and a generally elongated tool handle extending therefrom, comprises a first end pivotally mounted on the tool handle and a free second end distal therefrom. The tool stand is pivotable between a retracted position, where the second end is positioned substantially adjacent the tool handle, and an extended position, where said second end is positioned away from the tool handle and engages a support surface to support the tool in a generally upright position.

In another aspect of the present invention, a tool stand adapter unit for supporting a tool having a tool head and a generally elongated tool handle extending therefrom comprises an adapter member or mount to which a retractable tool stand is pivotally connected at a pivot joint. The tool stand is connected to the adapter member at a first pivot end, and further includes a free second distal end pivotable between a retracted position, where the distal end is positioned substantially adjacent the tool handle, and an extended position, where the distal end projects outwardly from the adapter member to engage a support surface and support the tool in a generally upright position. The adapter member engages at least the tool handle to pivotally mount the tool stand with respect to the tool handle.

These and other features of the present invention are described with reference to the drawings of preferred embodiments of a retractable tool stand, the combination of the tool stand with a tool having a generally elongated tool handle, and after-market tool stand adapter units for use with a tool having a generally elongated tool handle. The illustrated embodiments of the retractable tool stand of the present invention are intended to illustrate, but not limit the invention.

### BRIEF DESCRIPTION OF THE DRAWINGS

FIG. 1 is an elevation perspective view of a push broom and a retractable stand structure in accordance with an embodiment of the present invention supporting the broom in a generally upright and vertical orientation.

FIG. 2 is a side view of the push broom and retractable stand structure of FIG. 1 illustrating pivoting of the stand structure between an extended position and a retracted position.

FIG. 3 is a side view of an alternate embodiment of the push broom and retractable stand structure combination illustrating pivoting of the stand structure between an extended position and a retracted position.

FIG. 4 is an exploded perspective view of a retractable stand structure in accordance with the present invention to be connected to a tool handle.

FIG. 5 is an exploded top view of the retractable stand structure shown in FIG. 4.

FIG. 6 shows an elevation perspective view of a push broom and an embodiment of a retractable stand structure in accordance with the present invention connected to an elongated handle of the broom, where the stand structure is articulated to an extended position so as to support the broom in a generally upright and vertical orientation.

FIG. 7 shows an elevation perspective view of the push broom and retractable stand structure of FIG. 6 showing the stand structure articulated to a retracted position.

FIG. 8 is an exploded perspective view of the retractable stand structure of FIG. 6.

FIG. 9 is a cross-sectional side view of the push broom and retractable stand structure of FIG. 6 with the stand structure in an extended position.

FIG. 10 is a cross-sectional side view of the push broom and retractable stand structure of FIG. 6 with the stand structure in a retracted position.

FIG. 11 is a plan view of an elongated handle provided with a plurality of retractable stand structures in accordance with the present invention, each stand structure being articulated to an extended position.

FIG. 12 is a plan view of the elongated handle and plurality of retractable stand structures of FIG. 11 where each stand structure is articulated to a retracted position.

FIG. 13 shows an embodiment of a retractable stand structure in accordance with the present invention including an adapter unit to be used with a tool having an elongated handle.

FIG. 14 shows an embodiment of a retractable stand structure in accordance with the present invention including an alternative adapter unit to be used with a tool having an elongated handle.

### DETAILED DESCRIPTION OF THE INVENTION

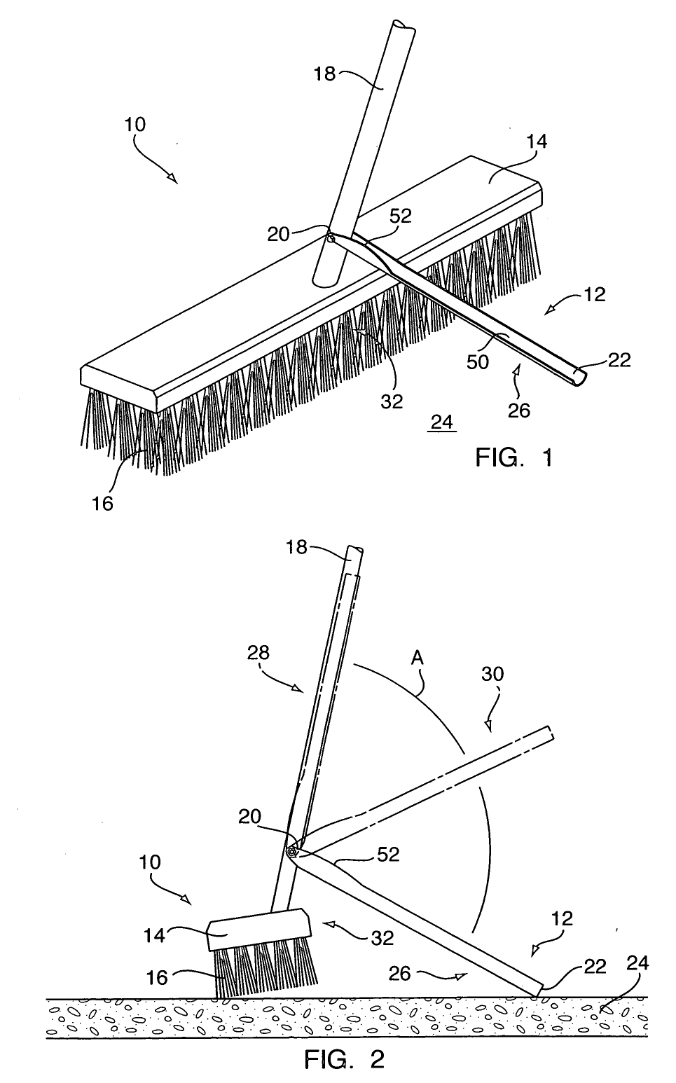

FIGS. 1 and 2 illustrate a conventional push broom 10 with which a retractable stand 12 in accordance with the present invention may be used. The broom 10 generally comprises a broom head 14 to which a plurality of bristles 16 is attached, and from which an elongated, generally cylindrical handle 18 extends. The stand 12 generally comprises a pivot end 20 pivotally connected to or otherwise mounted on the handle 18, and a distal support end 22 opposite from the pivot end 20 that contacts a generally horizontal support surface, such as a floor, illustrated as reference number 24, when the stand 12 is extended. In operation, as illustrated in FIG. 2, the stand 12 is preferably articulated between an extended position 26, where the broom 10 may be propped up and temporarily stored in a generally upright orientation, and a retracted position 28, where the stand 12 is stored adjacent to the broom handle 18 so that the broom 10 may be used for sweeping without the stand 12 getting in the way. An intermediate position 30 is illustrated in broken lines to show movement of the stand 12 between the extended position 26 and the retracted position 28 along path A. Various designs and components of the stand 12 are described in more detail below. Although illustrated for use with a conventional push broom, the present invention can be used with any tool having a generally elongated handle, including rakes, shovels, mops, floor squeegees, concrete floats, paint rollers with extension handles, and the like.

The stand 12, when extended, permits the broom 10 to be propped up and stored in a generally upright orientation. Preferably, the broom 10 is temporarily stored in a conventional push position, as illustrated in FIG. 2—i.e., the bristles 16 of the broom 10 are set on a generally horizontal floor surface 24, the broom head 14 is generally parallel to the surface 24, and the handle 18 is slightly inclined towards the user, who can push and pull the broom forward and backward in a sweeping motion to clean the surface 24 interacting with the bristles 16. To store the broom 10 in such a position, the stand 12 is mounted to the handle 18 so that it extends from the rear face of the broom 10, generally designated as reference number 32. The advantage of storing the broom 10 in such a position is that sweeping can be resumed quickly by retracting the stand 12 without the need for twisting or repositioning of the broom head 14 with respect to the surface to be cleaned. Thus, during a sweeping chore, if a piece of furniture needs to be moved, the stand 12 can be extended, the broom 10 temporarily stored in a generally upright orientation in the push position, the object moved, the stand 12 retracted, and the task resumed without taking up too much time to set-up and break down the stand 12. Also, retraction can be facilitated by exerting some downward pressure on the broom handle 18, which will begin pivoting and retraction of the stand 12 along path A.

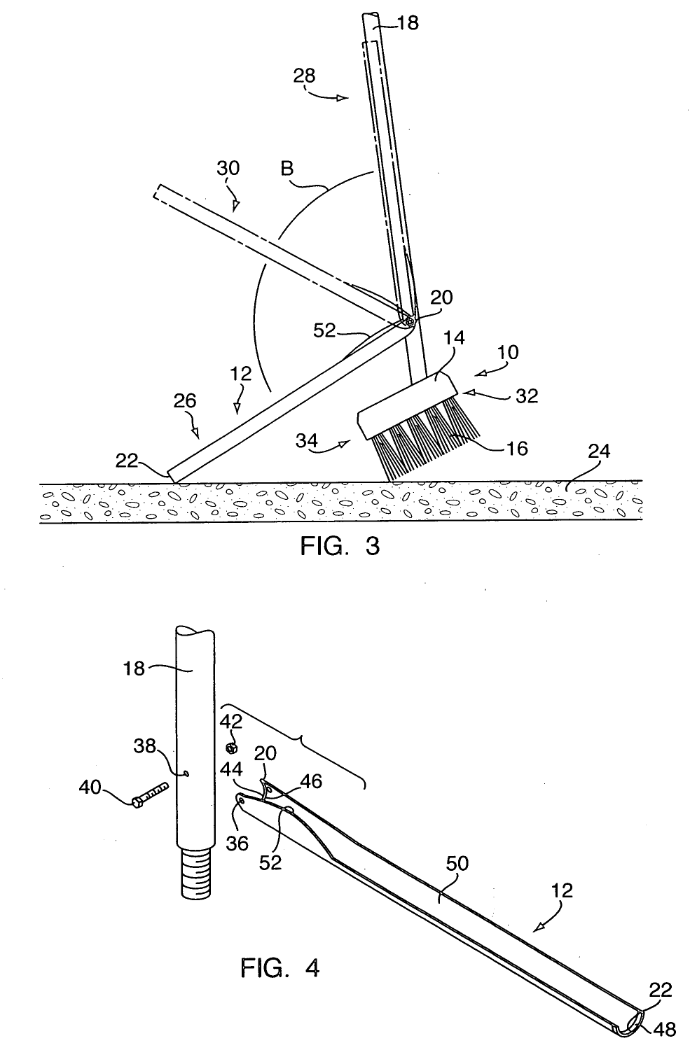

In an alternative embodiment illustrated in FIG. 3, the stand 12 can be mounted to the handle 18 so that it extends from the front face of the broom 10, generally designated as reference number 34. As so mounted, the stand 12 is articulated between the extended position 26 and the retracted position 28, through the intermediate position 30, along path B. In such an embodiment, the broom 10 is rotated away from the conventional push broom position shown in FIG. 2, and is temporarily stored in a position where most of the bristles 16 are held off the generally horizontal floor surface 24 and the handle 18 is slightly forwardly inclined, away from the user's position. Such a position requires the broom 10 to be tilted backwards or flipped around in order to resume use of the broom 10, and to retract the stand 12, the user will need to reach around to the front face 34 of the broom 10. However, this embodiment is advantageous if the user wants to avoid accidental retraction of the stand 12 when slight downward pressure is exerted on the handle 18 towards the rear face 32 of the broom 10, or if the user doesn't want the stand 12 to be positioned where the user would be standing during use of the broom 10, so as to avoid tripping over the stand 12 when reaching for the handle 18.

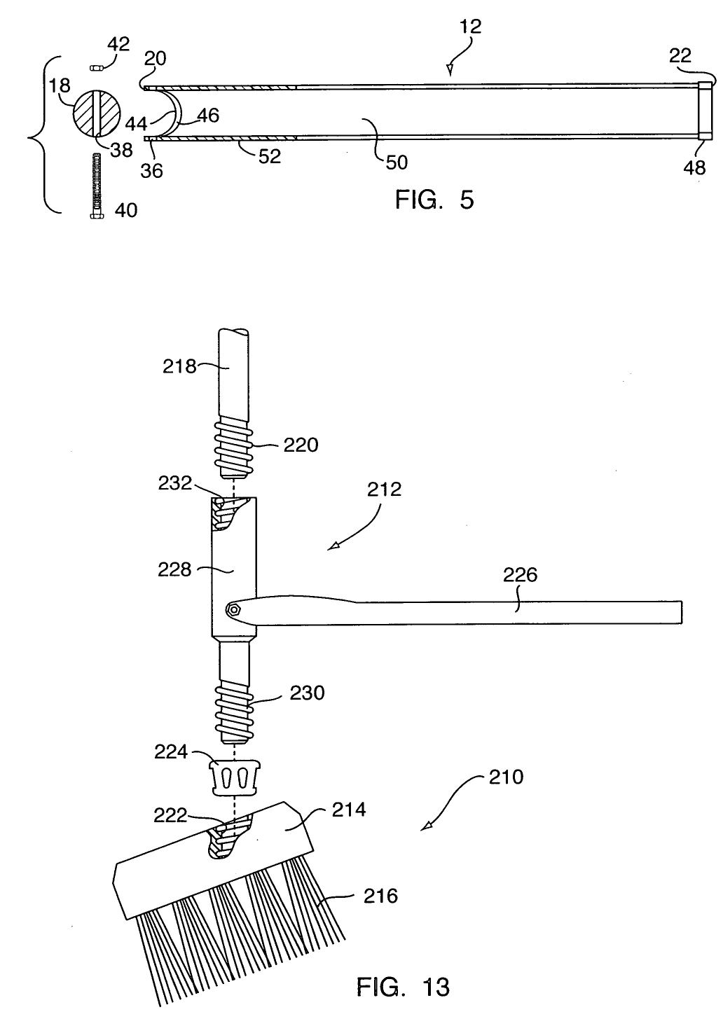

Referring to FIGS. 4 and 5, a preferred design for the stand 12 of the present invention is illustrated. As shown, the stand preferably has a generally elongated form such that the pivot end 20 and the distal end 22 are at opposing longitudinal ends of the stand 12. The stand 12 is pivotally secured in place at a suitable pivot position on the handle 18 so that the stand 12, when extended, will engage a support surface at the distal end 22 to prop up and support the tool in a generally upright orientation. When the stand 12 is retracted, the stand is disposed generally parallel to the handle 18 such that the distal end 22 is positioned substantially adjacent the handle 18. Preferably, the stand 12 is held substantially flush against the handle 18 in the retracted position 28 so that it doesn't interfere with use of the tool.

The pivot end 20 of the stand 12 includes a pivot hole 36 that is lined up with a hole 38 formed in the handle 18. A mounting bolt 40 is inserted through the pivot hole 36 in the stand 12 as well as the hole 38 in the handle 18 and held in place with a nut 42 or other common connection means. Accordingly, in the design of the stand 12 illustrated in FIGS. 4 and 5, the stand 12 generally pivots about the axis of the mounting bolt 40. The pivot end 20 also preferably includes a notch 44 that matches the shape of the handle 18 for mating with the outer surface of the handle 18 when the stand 12 is pivoted to its extended position 26. As illustrated in FIG. 5, the notch 44 has a generally arced shape to correspond to the generally cylindrical shape of the illustrated handle 18. The notch 44 may be covered with a buffer 46, preferably made from a rubber or elastic material, to prevent the stand 12 from cutting into the handle 18 (which could damage or weaken the handle and lead to the handle breaking), especially where pressure is exerted onto the handle 18 that forces the end of the stand 12 into contact with the handle 18. The distal support end 22 can also be provided with a buffer 48, preferably made from a rubber or elastic material, to prevent the stand 12 from scratching a floor surface with which it may make contact when in the extended position 26.

The stand 12 preferably has an inner channel 50 that complements the shape of the outer surface of the handle 18. As shown, the stand 12 has a concave inner channel 50 that will partially wrap around the generally cylindrical shape of the handle 18 and hold the stand 12 substantially flush against the handle 18 when the stand 12 is pivoted to its retracted position 28, as shown in FIGS. 2 and 3. In such retracted position 28, the stand 12 preferably fits snuggly around the handle 18 so as to avoid accidental extension of the stand 12. Additionally, the cross-section of the stand 12 can be designed with respect to the outer surface of the handle 18 so that the stand can be snap-fit around the handle 18 to prevent extension of the stand 12 without some force being exerted on the stand 12 by the user. For example, the stand 12 shown in FIG. 4 has a generally curved inner channel 50 that has a radius slightly smaller than the radius of the generally cylindrical handle 18. The inner channel 50 will flex outwardly when engaging the handle 18 to create a snap-fit connection between the stand 12 and the handle 18.

Where the stand 12 is snugly snap-fit to the handle 18, a projection in the form of rib 52 can be provided on the stand 12 to assist the user in disconnecting the stand 12 from the handle 18 so that it can be articulated to its extended position 26. That is, the rib 52 projects beyond the diameter of the handle 18 when the stand is in the retracted position 28, as illustrated in FIG. 2. To disengage the stand 12 from the handle 18, the user can press on the projected portion of the rib 52 to break the snap-fit connection and pivot the stand 12 to the extended position 26. As shown in FIG. 4, the rib 52 is located near the pivot end 20 of the stand 12. Alternatively, the rib 52 can be positioned at any location along the length of the stand 12 to facilitate use of the stand 12. The rib 52 also provides added stability to the stand 12 so that it can withstand greater pressure or weight exerted on the tool.

The outer surface 54 of the stand 12 preferably matches the shape of the handle 18 so that when the stand 12 is in the retracted position 28 it does not interfere with the user's grip on the handle 18 or the use of the tool. To this end, the outer surface 54 of the stand 12 can be made from or covered with a grip material to facilitate use of the tool. In general, the stand 12 should be constructed from a material that provides longitudinal rigidity so that the stand 12 will adequately support the weight of the tool and withstand slight pressure exerted on the tool by the user. Additionally, the stand material may provide some cross-sectional elasticity and flexibility so the stand 12 can be snap-fit around the handle 18 when in the retracted position 28 yet still permit the user to easily disengage the stand 12 from the handle 18 to pivot it to the extended position 26. Preferable materials for the stand 12 include plastics or lightweight metals, such as aluminum.

During use of the tool, the stand 12 should be maintained in the retracted position 28. To make use of the stand 12, the user can disengage the stand 12 from the tool handle 18, such as by using the rib 52 to separate the connection between the inner channel 50 of the stand 12 and the outer surface of the handle 18, and pivot the stand 12 downward until the notch 44 in the pivot end 20 of the stand 12 contacts the handle 18 and restricts further pivoting of the stand 12. The tool and the stand 12 should be lowered until the distal support end 22 of the stand 12 contacts the ground 24 and props the tool in a generally upright orientation. Accordingly, when the user of the tool wants to take a break, the stand 12 can be easily and quickly articulated into position for temporary storage of the tool. When the user wants to resume working with the tool, the user can easily grab the tool, pivot the stand 12 from the extended position 26 to the retracted position 28 using a hand or a foot, and fit the stand 12 snugly against the handle 18 where the stand will not affect the user's grip on the handle 18 and will not interfere with the use of the tool. Preferably, the stand 12 is maintained in the retracted position 28 during long-term storage, such as on a hook or in a storage rack, so as to avoid warping or damage to the stand 12.

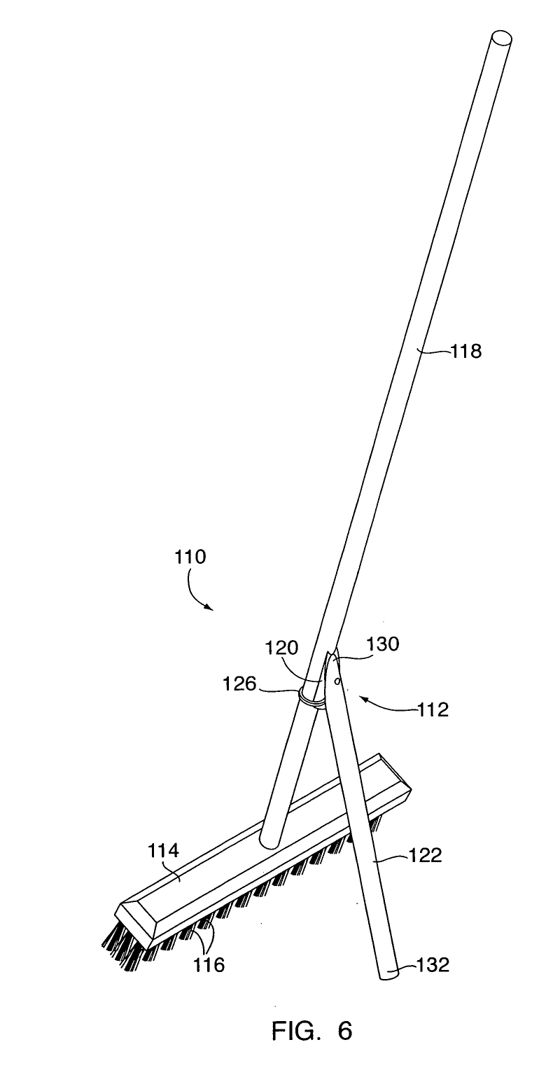

The stand 12 of the present invention may be attached to a tool handle during manufacture, or sold separately as an after-market attachment for tools manufactured or sold without any such means to prop up or temporarily store the tool in an upright orientation. FIGS. 6-10 illustrate a conventional push broom 110 that may be equipped with an embodiment of such an after-market adapter unit 112 for a retractable tool stand of the present invention, which could also alternatively be incorporated into the design of the broom 110 itself. Although illustrated for use with a conventional push broom, after-market adapter units in accordance with the present invention, such as unit 112, may be used with any tool having a generally elongated handle, including rakes, shovels, mops, floor squeegees, concrete floats, paint rollers with extension handles, and the like.

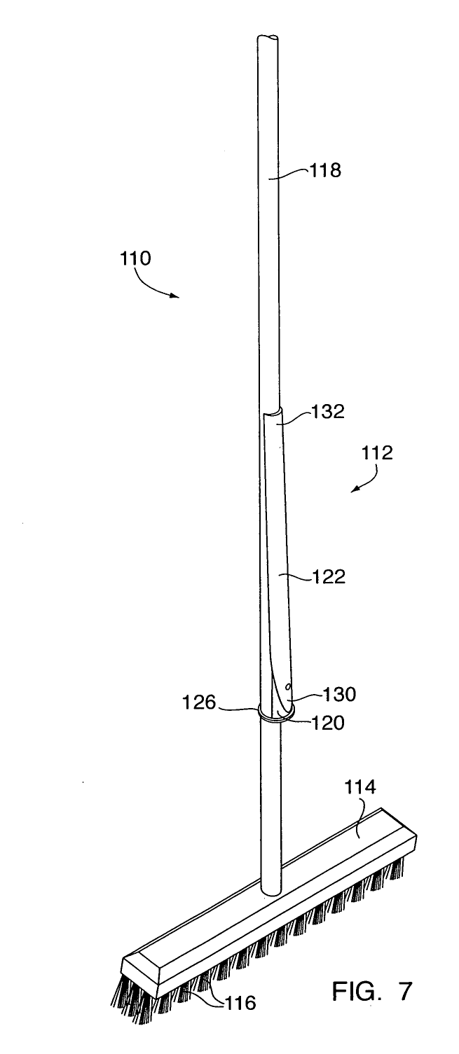

The push broom 110 generally includes a broom head 114 to which a plurality of bristles 116 is attached, and from which an elongated, generally cylindrical handle 118 extends. The adapter unit 112 comprises a stand mount 120 and a tool stand 122 mounted thereon for articulation between an extended position (FIG. 6), where the tool can be stored in a generally upright orientation, and a retracted position (FIG. 7), where the tool can be used as intended without interference from the stand 122. As shown, the stand mount 120 is designed for after-market application, namely, the mount 120 comprises a separate longitudinal member with a concave groove 124 that complements and mates with the outer surface of the broom handle 118, with means for securing the mount 120 to the handle 118 in a desired location. Specifically, the illustrated mount 120 is secured to the handle 118 using a hose clamp 126, although alternative means, such as a bolt through the handle, or a sleeve slidingly fitted over the end of the handle, may be used. The mount 120 also includes a mounting face 128 to which the tool stand 122 is pivotally mounted.

The tool stand 122 generally comprises a pivot end 130 and a distal support end 132. The pivot end 130 has a pivoting face 134 that generally complements shape and contour of the mounting face 128 of the mount 120. The mounting face 128 and the pivoting face 134 each includes a respective bore 136 and 138 generally perpendicular to the face in which it is provided. The bores 136 and 138 receive a pivot bolt 140 so as to connect the tool stand 122 to the mount 120 for pivotal movement about the axis of the pivot bolt 140. The pivot bolt 140 may also include a spring tensioner (not shown) to strengthen the joint between the mount 120 and the tool stand 122 and increase the load carrying capacity of the tool stand 122.

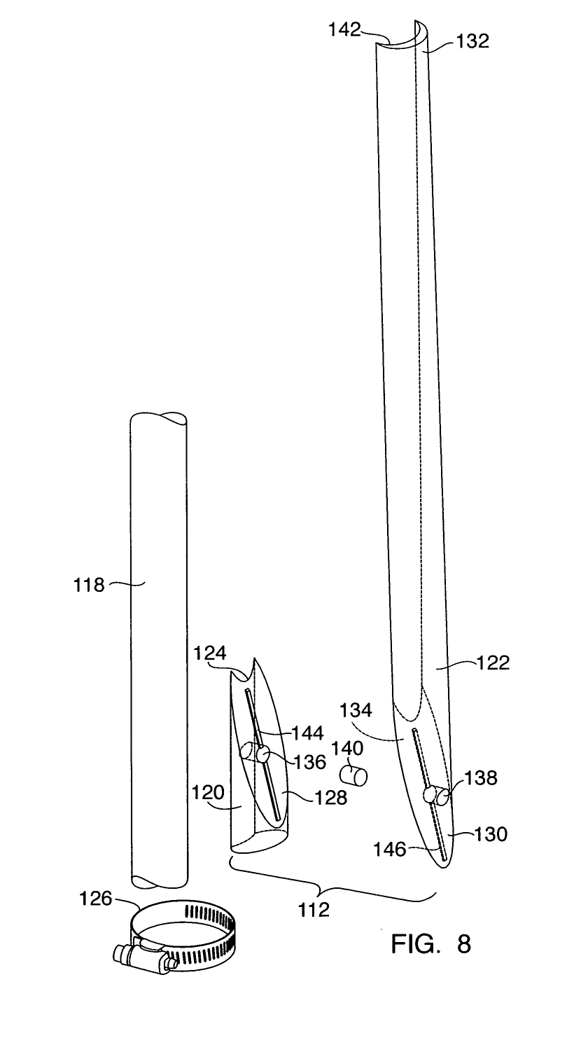

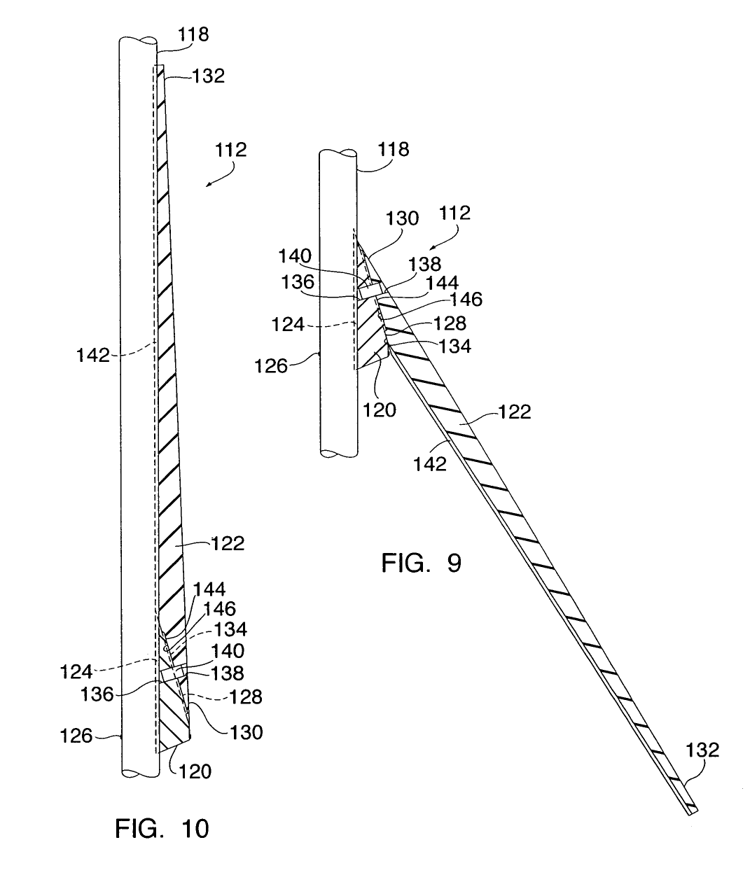

As shown in FIGS. 8-10, the mounting face 128 and the pivoting face 134 are angled from the axis of the handle 118. Such angular relationship between the mount 120 and the tool stand 122 permits the tool stand 122 to be positioned at an angular relationship to the handle 118 when in the extended position (FIG. 9), while essentially being a linear extension of the mount 120 when in the retracted position (FIG. 10). When in the retracted position, the tool stand 122 is disposed generally parallel to the tool handle 118 such that the distal end 132 is positioned substantially adjacent the handle 118. Preferably, the tool stand 122 is provided with a concave groove 142 that complements the shape of the outer surface of the handle 118, and more preferably mates with the handle 118 to secure the tool stand 122 against the handle 118 in the retracted position. Moreover, the tool stand 122 is preferably tapered from the pivot end 130 to the distal end 132 so as to reduce interference with the grip of the handle 118 when the tool is being used. When the tool stand 122 is in the extended position, the distal end 132 is positioned away from the tool handle 118 and engages a support surface to support the tool 110 in a generally upright position.

The complementary mounting face 128 and pivoting face 134 are also preferably provided with means to ensure that the tool stand 122 is locked into desired positions, namely, the retracted position, the extended position, or any intermediate position to which the user desires to pivot the tool stand. As shown, the mounting face 128 is provided with a locking rib 144 and the pivoting face 134 is providing with a complementary locking groove 146 (though the positioning of the locking rib 144 and the locking groove 146 could be reversed), each extending generally along a plane of the axis of the handle 118. As the tool stand 122 is pivoted relative to the mount 120, it will snap into position when the locking groove 146 aligns with the locking rib 144. In the embodiment illustrated, the locking groove 146 aligns with the locking rib 144 in two positions (separated by 180 degrees), which correlate to the retracted and extended positions of the tool stand 122.

During use of the tool, the stand 112 should be maintained in the retracted position. To use the stand 122, the user can apply pressure to the stand 122 to disengage the locking groove 146 from the locking rib 144 and then articulate the stand 122 with respect to the mount 120 about the pivot axis defined by the pivot bolt 140. The stand 122 is pivoted while maintaining the pivoting face 134 against the mounting face 128 until the locking groove 146 once again aligns with the locking rib 144 to lock the stand 122 in place at the extended position. The tool 110 and stand 122 can be lowered until the distal support end 132 of the stand 122 contacts the ground and props the tool in a generally upright orientation. Accordingly, when the user wants to take a break, the stand 122 can be easily and quickly articulated into position for temporary storage of the tool. When the user wants to resume working with the tool, the user can easily pivot the stand 122 from the extended position back to the retracted position after disengaging the locking groove 146 from the locking rib 144, and fit the stand 122 snugly against the handle 118 when the locking groove 146 re-engages the locking rib 144 where the stand 122 will not affect the user's grip on the handle 118 and will not interfere with use of the tool.

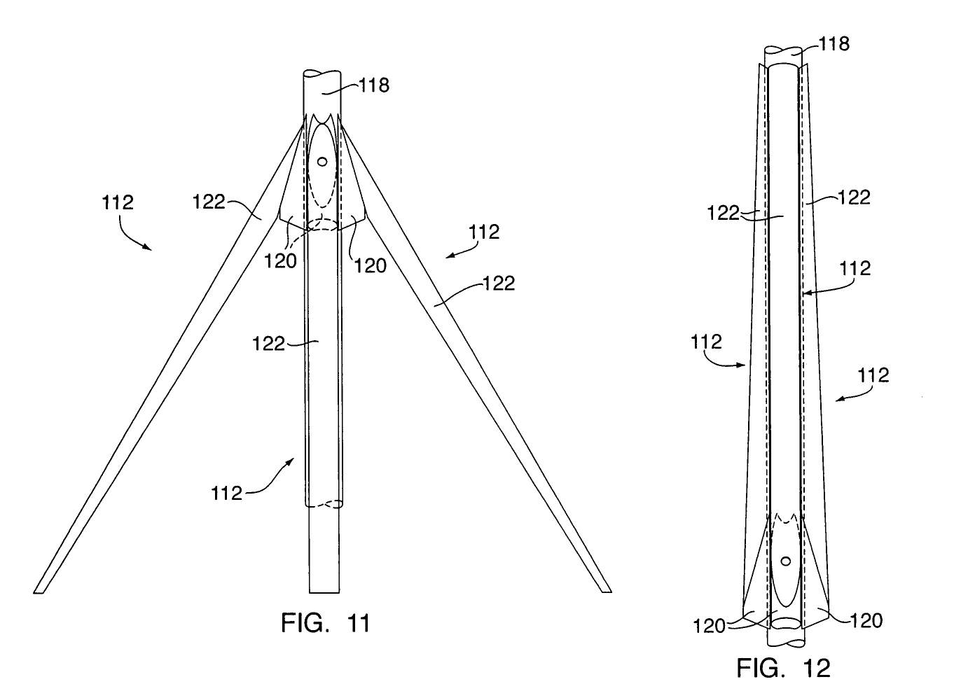

FIGS. 11 and 12 illustrate a use of the adapter unit 112 where a plurality of mounts 120 and pivotable tool stands 122 are provided on an elongated tool handle 118. As illustrated, three such adapter units 112 are positioned about the handle 118 so as to create a tripod to support the tool in a generally upright position when each of the tool stands 122 are articulated to their respective extended positions. With such a set-up, the adapter units 112 can be positioned near the tool head 114, e.g., in the manner illustrated in FIG. 6, or alternatively be positioned at the other end of the handle 118 and directed away from the tool head 114 so as to hold the tool head off the ground when the tool is temporarily stored using the tool stands. When each of the tool stands 122 are pivoted to their respective retracted positions, the tool can be used without interference from any of the adapter units 112. Accordingly, the tool stand of the present invention has utility for temporary storage of tools having elongated handles, as well as for other construction site applications, such as use with elongated posts or handles to be used as delineator posts, markers, tripods, or stands.

FIG. 13 illustrates a conventional push broom 210 that may be equipped with an alternative embodiment of an after-market adapter unit 212 for a retractable tool stand of the present invention. The push broom 210 generally includes a broom head 214 to which a plurality of bristles 216 is attached, and from which an elongated, generally cylindrical handle 218 extends. In accordance with common designs for tools having generally elongated handles, the handle 218 has a threaded end 220 that can be screwed into a threaded recess 222 provided in the broom head 214. An adjustment nut 224 is also often provided to ensure a secure connection between the handle 218 and the broom head 214.

The adapter unit 212 comprises a tool stand 226 of the type generally described herein pivotally connected to an adapter handle section 228. The adapter handle section 228 has generally the same cross-sectional shape as the broom handle 218 with which the adapter unit 212 can be used, and further includes a first threaded end 230 for engagement with the threaded recess 222 in the broom head 214, and a second end including a threaded recess 232 for engagement with the threaded end 220 of the broom handle 218. The adjustment nut 224 can be used on the threaded end 230 of the adapter handle section 228 to ensure a secure connection between the adapter unit 212 and the broom head 214.

Once the adapter unit 212 is secured to the tool, the stand 226 is pivotable between an extended position, where the tool can be stored in a generally upright orientation, and a retracted position, where the tool can be used as intended without interference from the stand 226. In the retracted position, the stand 226 engages the outer surface of the adapter handle section 228 as well as a portion of the outer surface of the broom handle 218, and overlaps the joint between the adapter handle section 228 and the broom handle 218. In preferred embodiments of the adapter unit 212, the adapter handle section 228 is between about 4 and about 12 inches long so that the overall handle length, with the adapter handle section 228 attached to the tool handle 218, is not too long or unwieldy for the user of the tool.

Although described with respect to connections using respective male and female threads, the adapter unit 212 of the present invention can be adapted to any common connection means for connecting the elongated handle to the tool head such that the handle is connected to the adapter unit, which in turn is connected to the tool head without affecting use of the tool in the intended manner.

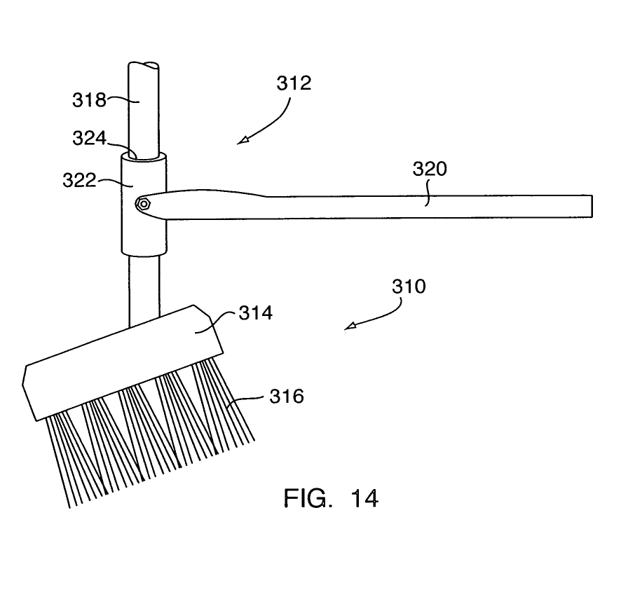

Referring to FIG. 14, an alternative form of an adapter unit embodying a retractable tool stand in accordance with the present invention is illustrated. As shown, a conventional broom 310 is provided with an after-market adapter unit 312. The push broom 310 generally includes a broom head 314 to which a plurality of bristles 316 is attached, and from which an elongated, generally cylindrical handle 318 extends. The adapter unit 312 comprises a tool stand 320 of the type generally described herein pivotally connected to an adapter sleeve 322. The adapter sleeve 322 has a central slot 324 that generally complements the cross-sectional shape of the handle 318 so that the adapter sleeve 322 can be slid onto the handle 318 to mount the adapter unit 312 on the broom 310. Alternatively, the adapter sleeve 322 can be configured to be snap-fit around the handle 318 or provided with a hinge to facilitate mounting the adapter sleeve 322 onto the handle as a collar so that the adapter unit 312 can be used with a tool having a handle of varying cross-section or tool with a broad handle portion at the end of the handle away from the tool head, such as a shovel with a closed-loop grip portion at the end.

Once the adapter unit 312 is secured to the tool, the stand 320 is pivotable between an extended position, where the tool can be stored in a generally upright orientation, and a retracted position, where the tool can be used as intended without interference from the stand 320. In the retracted position, the stand 320 engages the outer surface of at least the adapter sleeve 322, and is generally adjacent the outer surface of the broom handle 318 so as to not interfere with the user's grip on the handle 318 or the general use of the tool.

In any of the above-described embodiments, a retractable tool stand in accordance with the present invention permits a tool having an elongated handle to be temporarily stored in a generally upright or vertical orientation at any location desired by the user. Such temporary upright storage reduces the risk of damage to the tool and injury to the user or anyone else who may pass through the work area by making the tool easier to see than if it were laid flat on the ground or floor. The generally upright storage position of the tool facilitated by the retractable tool stand also allows the tool to be employed as a temporary delineator post. For example, the tool can be used to mark a work stopping point or an otherwise unobtrusive pile of debris. In the work environment, debris, such as construction trash, may contain nails or other sharp objects. Low-lying piles of debris are not always easily visible, especially for equipment operators on a construction site. Setting a tool, such as a push broom, as a delineator post near the debris pile provides a visible indicator to alert workers to steer clear of potential damage and avoid passing through the pile and tracking debris over areas that had already been cleaned. The tool can also be positioned at the debris pile to remind the user where the task left off so as to eliminate unnecessary duplication of work. Further, the tool can be used with caution tape to cordon off an area, or provided with a sign—e.g., attached to the elongated handle—to provide warnings of hazards in the area, such as a slippery floor or wet paint.

The foregoing description of embodiments of the invention has been presented for the purpose of illustration and description, it is not intended to be exhaustive or to limit the invention to the form disclosed. Obvious modifications and variations are possible in light of the above disclosure. The embodiments described were chosen to best illustrate the principals of the invention and practical applications thereof to enable one of ordinary skill in the art to utilize the invention in various embodiments and with various modifications as suited to the particular use contemplated. It is intended that the scope of the invention be defined by the claims appended hereto.

What is claimed is:

1. A tool stand for supporting a tool having a tool head and a generally elongated tool handle extending therefrom, said tool stand comprising:
a first end pivotally mounted on the tool handle; and
a free second end distal from said first end;
wherein said tool stand is pivotable between a retracted position, where said second end is positioned substantially adjacent the tool handle, and an extended position, where said second end is positioned away from the tool handle and engages a support surface to support the tool in a generally upright position.

2. The tool stand of claim 1, wherein said tool stand is defined by a generally elongated member having said first end and said second end at opposing longitudinal ends thereof, and further wherein the elongated member is generally parallel to the axis of the tool handle when the tool stand is in the retracted position.

3. The tool stand of claim 2, wherein said elongated member defines an inner channel that abuts the outer surface of the tool handle when the tool stand is in the retracted position.

4. The tool stand of claim 3, wherein the inner channel generally complements the shape of the outer surface of the tool handle so as to be held substantially flush against the handle when the tool stand is in the retracted position.

5. The tool stand of claim 3, wherein the elongated member is snap-fit into engagement with the tool handle to hold the tool stand against the tool handle in the retracted position.

6. The tool stand of claim 1, further comprising:
an adapter member pivotally connected to the first end of the tool stand;
wherein the adapter member engages at least the tool handle to pivotally mount the tool stand with respect to the tool handle.

7. The tool stand of claim 6, wherein the adapter member includes a mounting face engaging a complementary pivoting face provided on the first end of the tool stand, said mounting face and said pivoting face forming a joint about which the tool stand can be articulated relative to the adapter member between the retracted position and the extended position.

8. The tool stand of claim 7, further comprising a pivot bolt connecting the adapter member to the tool stand and being perpendicularly disposed to the mounting face and the pivoting face, and wherein the tool stand is pivotable relative to the adapter member about the axis of said pivot bolt.

9. The tool stand of claim 8, wherein the mounting face and the pivoting face are angled from the longitudinal axis of the handle, said respective angled faces generally cooperating to position the tool stand generally parallel to the tool handle when the tool stand is in the retracted position and at an angular position relative to the tool handle when the tool stand is in the extended position.

10. The tool stand of claim 6, wherein the adapter member has a generally elongated shape and includes longitudinally opposed ends, one of said opposed ends engaging the tool handle and the other of said opposed ends engaging the tool head such that the adapter member essentially acts as an extension of the tool handle.

11. The tool stand of claim 6, wherein the adapter member comprises a sleeve configured to be slid over the tool handle to mount the tool stand with respect to the tool handle.

12. In combination:
(a) a tool comprising a tool head and a generally elongated handle; and
(b) a tool stand for supporting the tool in a generally upright position, said tool stand comprising:
a first end pivotally mounted on the tool handle; and
a free second end distal from said first end;
wherein said tool stand is pivotable between a retracted position, where said second end is positioned substantially adjacent the tool handle, and an extended position, where said second end is positioned away from the tool handle and engages a support surface to support the tool in a generally upright position.

13. The combination of claim 12, wherein said tool stand is defined by a generally elongated member having said first end and said second end at opposing longitudinal ends thereof, and further wherein the elongated member is generally parallel to the axis of the tool handle when the tool stand is in the retracted position.

14. The combination of claim 13, wherein said elongated member defines an inner channel that generally complements the shape of the outer surface of the tool handle so as to be held substantially flush against the handle when the tool stand is in the retracted position.

15. The combination of claim 13, wherein the elongated member is snap-fit into engagement with the tool handle to hold the tool stand against the tool handle in the retracted position, and further comprises a projection for disengaging the elongated member from the tool handle so that the tool stand can be pivoted to the extended position.

16. The combination of claim 12, further comprising:
an adapter member engaging at least the tool handle to pivotally mount the tool stand with respect to the tool handle,
wherein the first end of the tool stand is pivotally connected to the adapter member and the second end of the tool stand is positioned distal from the adapter member for pivotal movement between the retracted position and the extended position.

17. A tool stand adapter unit for supporting a tool have a tool head and a generally elongated tool handle extending therefrom, said tool stand adapter unit comprising:
a mount engaging at least the tool handle;
a tool stand having a first pivot end and a free second distal end; and
a pivot joint at which the pivot end of the tool stand is pivotally connected to the mount such that the tool stand is articulatable between a retracted position, where the distal end is positioned substantially adjacent the tool handle, and an extended position, where the distal end projects outwardly from the mount to engage a support surface and support the tool in a generally upright position.

18. The tool stand adapter unit of claim 17, wherein the mount comprises a generally elongated adapter handle portion having longitudinally opposed ends, wherein one of said opposed ends is configured to engage the tool head and the other of said opposed ends is configured to engage the tool handle when said adapter handle portion is mounted to the tool.

19. The tool stand adapter unit of claim 18, wherein one of said opposed ends of the adapter handle portion includes threads and the other of said opposed ends includes a threaded recess to facilitate engagement of the adapter handle portion with the tool head and the tool handle.

20. The tool stand adapter unit of claim 18, the stand further comprising:
a generally elongated member having said pivot end and said distal end at opposing longitudinal ends thereof; and
an inner channel that generally complements the shape of the outer surface of at least the adapter handle portion so as to be held substantially flush against the adapter handle portion when the stand is in the retracted position, and
wherein the elongated member is generally parallel to the axis of the tool handle when the stand is in the retracted position.
